(19) United States
(12) Patent Application Publication
(10) Pub. No.: US 2016/0094141 A1
(43) Pub. Date: Mar. 31, 2016

(54) SINGLE CONVERSION STAGE BIDIRECTIONAL SOFT-SWITCHED AC-TO-AC POWER CONVERTER

(71) Applicant: Greecon Technologies Ltd., Burnaby (CA)

(72) Inventors: Roumen Dimitrov PETKOV, Burnaby (CA); Gueorgui Iordanov ANGUELOV, Burnaby (CA)

(21) Appl. No.: 14/865,548

(22) Filed: Sep. 25, 2015

Related U.S. Application Data
(60) Provisional application No. 62/055,458, filed on Sep. 25, 2014.

(51) Int. Cl. H02M 5/293; H02M 1/42

(52) U.S. Cl. CPC H02M 5/293; H02M 1/42

(57) ABSTRACT

A single conversion stage bidirectional soft-switched AC/AC power converter system is capable of converting power in both directions between high- and low-voltage sources. The system has substantially loss-less switching and regulated output in both directions of power transfer. The semiconductor and electro-magnetic components of the system provide both output regulation and soft switching in both the step-up and the step-down directions of power conversion. The commonality of components between the two directions of power transfer reduces total component count, cost and volume, and enhances power conversion efficiency. An associated method of power transfer employs structural symmetry in a resonant circuit of the system to ensure high efficiency line power transfer in both directions.

### CROSS REFERENCE TO RELATED APPLICATIONS

This application claims the benefit under 35 U.S.C. §119 of U.S. Application No. 62/055,458 filed 25 Sep. 2014, and entitled SINGLE CONVERSION STAGE BIDIRECTIONAL SOFT-SWITCHED AC-TO-AC POWER CONVERTER which is hereby incorporated herein by reference for all purposes.

### FIELD OF THE INVENTION

The present invention relates to a bidirectional and isolated AC-to-AC power converters.

### BACKGROUND OF THE INVENTION

Today's switched mode power converters are typically required to provide insulation between the primary and secondary sides and to have high power density, high efficiency and low cost. In addition, many applications including uninterruptible power supplies (UPS), power supplies utilizing renewable energy sources (e.g. solar, wind, fuel cells), as well as aerospace power supplies require bidirectional (step-up and step-down) power conversion with isolated and regulated output. Examples of isolated and pulse width modulation (PWM) regulated bidirectional DC to DC (DC/DC) converters are described in U.S. Pat. No. 5,140,509, U.S. Pat. No. 5,255,174, U.S. Pat. No. 7,433,207, U.S. patent Ser. No. 63/700,501 and U.S. Pat. No. 6,205,035. The pulse width modulation control techniques employed in these converters typically feature so called “hard-switching” which can lead to significant switching losses and adversely impact the ability to achieve high power densities and high power conversion efficiencies.

Zero-voltage switching (ZVS) and zero-current switching (ZCS) are well-established switching techniques. These techniques reduce switching losses, which in turn allows for higher switching frequencies, reduced size of magnetic components, increased power density and reduced cost. U.S. Pat. No. 5,539,630, U.S. Pat. No. 6,370,050 and U.S. Pat. No. 6,330,170 describe bidirectional converters that feature ZVS. These converters provide only one direction of power conversion.

Line frequency AC to AC (AC/AC) converters based on line frequency power transformers are very common and simple to build. However, these converters are bulky and heavy and their prices are rising due to the rising cost of the raw materials involved, including copper, aluminum and silicon steel.

Line frequency AC/AC converters based on switched mode technology, on the other hand, can be relatively very small, light and efficient. They are based on high frequency power conversion, which dramatically reduces the size and the price of the magnetic components involved. In addition, the price of switched mode AC/AC power converters is dropping because of the steadily reducing price of components.

A major challenge in building line frequency switched mode AC/AC converters resides in handling reactive loads. The phase-lagging line current, for example, stores energy in the load reactance at the zero crossings of the line voltage. This load reactance energy has either to be temporarily stored, or recovered to the source in a controlled manner. The latter is needed to retain a sinusoidal or other desirable line current waveform. Failure of the energy storage/recovery process described above results in load overvoltage and component failures.

One prior art method for dealing with stored energy in the load reactance is to store it temporarily in an energy storage component, such as, for example, a bulk capacitor. This principle is embodied in double-conversion line frequency switched mode AC/AC converters. Double conversion switched mode converters have two power stages connected in series. The first power stage is an AC/DC stage, which is followed by a second DC/AC stage. Such double conversion units have an intermediate DC bus with a large storage capacitor or a battery connected to that bus in order to deal with reactive line frequency loads. The main drawbacks of double conversion line frequency switched mode AC/AC converters are reduced power efficiency, increased complexity and cost. Examples of double conversion converters are provided in U.S. Pat. No. 8,664,037 B2, U.S. Pat. No. 7,679,941 B2, U.S. Pat. No. 6,879,062, U.S. Pat. No. 5,943,229, and U.S. Pat. No. 4,894,763.

Prior art multi-resonant converters are typically series type frequency controlled resonant converters having three resonant components: a resonant capacitor, a resonant inductor and a magnetizing inductor. The resonant components of such multi-resonant converters can be selected in relation to the operating frequency such that the converter will provide zero voltage switching (ZVS) for the switching devices connected to the power source and zero current switching (ZCS) for the switching devices connected to the load. In addition, the resonant components can be selected so that the ZVS and ZCS can be maintained when operating from no-load to full-load conditions. In such prior art multi-resonant converters the output voltage in the “reverse” direction cannot be controlled and such systems can therefore be employed only for power conversion in one direction. A multiresonant converter design procedure for meeting the above criteria for conversion in one direction is outlined in R. Petkov, “Analysis and Optimisation of a Multi-Resonant Converter Employed in a Telecom Rectifier”, 21st International Telecommunication Energy Conference Intelec′99, Copenhagen, Denmark, June 1999, poster 41; and Diambo Fu et al., “1 MHz High Efficiency LLC Resonant Converters with Synchronous Rectifier” 38-th Annual Power Electronics Specialists Conference PESC′07, Orlando, Fla., USA, June 2007, pp. 2404-2410 which are hereby incorporated herein by reference.

While several power converters known in the art are configured for bidirectional power conversion and allow controllable output in both directions, the so-called “Green Revolution” has tightened the conversion efficiency requirements to a point where efficiencies above 95% in both directions is demanded.

U.S. Pat. No. 8,363,427 B2 by Anguelov et al. describes a DC/DC power converter that implements bidirectional soft switching. This reference is directed toward DC/DC converters for a single polarity of input voltage and is therefore based on rectifying circuitry that make it inapplicable to AC/AC systems.

Against the above background, there remains a need for a high efficiency and low cost bidirectional line frequency AC/AC converter with a wide range of output voltage controllability in both directions of power transfer.

### SUMMARY OF THE INVENTION

Briefly, the present invention relates to improved bidirectional AC/AC converters. Some embodiments feature soft, substantially loss-less switching operation and output voltage controllability in both directions of power transfer. In addition, certain embodiments of the present invention can maintain soft-switching operation and output voltage controllability within the entire load operating range, from zero load to full load. In particular, an embodiment of the present invention provides an improved series-type frequency controlled bidirectional AC/AC resonant converter that not only allows for a full control of the output voltage in both directions of power transfer, but, when components are properly dimensioned, can provide ZVS for the input section devices (i.e. the ones connected to the power source) and ZCS for the output section devices (i.e. the ones connected to the load) in both directions of power transfer and for all load conditions. The combination of ZVS and ZCS for all devices enhances the power conversion efficiency. The use of the same components for bidirectional power conversion is a major contributor of achieving very high power density. The substantially loss-less switching provided by embodiments described in the present specification allows for further increase in the power density by operating at higher switching frequencies, also described herein as “chopping frequencies”. Increasing the chopping frequency allows the size of all magnetic and filter components to be reduced. This is a distinct advantage of certain embodiments of the present invention compared with Pulse Width Modulation-controlled bidirectional converters that feature hard switching in at least one of the directions of power conversion.

Various embodiments of the present invention can employ input, or primary section devices that are connected in full-bridge or half-bridge switcher (“chopper”) configurations that chop the input power source AC signal at the chopping frequency. The resulting modulated input power signal is then applied to a resonant network circuit, while the output or secondary section devices are connected in full-bridge or half-bridge configurations and are controlled via a control signal to restore the shape of the output signal to that of the input signal. When the direction of power transfer reverses, the control functions of the primary section devices and the secondary section devices are effectively swapped. That is the devices that have performed the signal restoration now perform the “chopping” function while the former chopper devices perform the signal restoration function. The resonant circuit of various embodiments of the present invention is arranged in such a way that, when power transfer reverses, both substantially lossless switching (i.e. ZVS and ZCS operation) and the output voltage controllability of the circuitry are maintained.

This invention has several aspects. These include methods for AC/AC power conversion, AC/AC power converters, and systems which provide bidirectional AC/AC power converters between a source and a load. In some embodiments, the load is a reactive load.

In a first aspect a method is provided for transferring electrical line power along opposing first and second paths through a closed loop series reactance network comprising first, second, and third phase-retarding elements and a phase-advancing element. The method comprises: providing to a first switcher circuit a first input bipolar AC electrical line voltage signal having a first input signal shape; first modulating the first input bipolar voltage signal at a first chopping frequency in the first switcher circuit; providing across the first phase-retarding element a first modulated input voltage signal from the first switcher circuit; extracting across the second phase-retarding element a first modulated resonator output voltage signal; and first restoring in a second switcher circuit the first input signal shape to the first modulated resonator output voltage signal to create a first restored output voltage signal. The first restoring may comprise second modulating the first output voltage signal at the first chopping frequency. Extracting the first modulated resonator output voltage signal may comprise extracting the first modulated resonator output voltage signal through a transformer. The method may further comprise reversing power transfer through the closed loop series reactance network.

Reversing the power transfer may comprise: providing to the second switcher circuit a second input bipolar AC electrical line voltage signal having a second alternating input voltage amplitude and a second input voltage signal shape; third modulating the second input bipolar voltage signal at a second chopping frequency in the second switcher circuit; providing across the second phase-retarding element a second modulated input voltage signal from the second switcher circuit; extracting across the first phase-retarding element a second modulated resonator output voltage signal; and second restoring in the first switcher circuit the second input voltage signal shape to the second modulated resonator output signal to create a second restored output voltage signal. The second restoring may comprise fourth modulating the second output voltage signal at the second chopping frequency. The second and fourth modulating may comprise square wave modulating. Providing the second modulated input power signal may comprise providing the second modulated input voltage signal through a transformer.

The first and second chopping frequencies may be greater than frequencies of the first and second line voltage signals. Preferably the first and second chopping frequencies are at least twenty times the frequencies of the first and second line voltage signals. More preferably the first and second chopping frequencies are at least 8 kHz. Most preferably, the first and second chopping frequencies are at least 16 kHz. The modulating may be square-wave modulating.

In another aspect, an AC to AC line frequency bipolar power converter is provided. The converter comprises: a closed loop series reactance network comprising a phase-advancing element and first, second, and third phase-retarding elements all connected in series; a first power transfer tank circuit comprising the phase-advancing element, the first phase-retarding element, and the second phase-retarding element, a second power transfer tank circuit comprising the phase-advancing element, the first phase-retarding element, and the third phase-retarding element; a first switcher circuit connected in parallel with the third phase-retarding element and in series with the first power transfer tank circuit; and a first load circuit connected in parallel with the second phase-retarding element and in series with the second power transfer tank circuit.

The first switcher circuit may comprise a set of first switcher input terminals disposed for selectably connecting to one of a first electrical load and a first electrical power source providing a first input bipolar AC electrical line voltage signal having a first input signal shape. The first load circuit may comprise a second switcher circuit, the second switcher circuit comprising a set of second switcher input terminals and a set of second switcher output terminals disposed and configured to connect selectably to one of a second electrical load and a second electrical power source providing a second input bipolar AC electrical line voltage signal having a second input signal shape.

The first switcher circuit may be configured for modulating at a first chopping frequency the first bipolar input line voltage signal to provide to the first power transfer tank circuit a first modulated input power signal when the second electrical load is connected to the set of second switcher output terminals and the first switcher input terminals are connected to the first electrical power source. The second switcher circuit may be configured for restoring the first input voltage signal shape to a first transmitted voltage signal obtained from the first power transfer tank circuit by modulating the first transmitted voltage signal at the first chopping frequency. The modulating may be square-wave modulating.

The second switcher circuit may be configured for modulating the second line voltage signal at a second chopping frequency to provide to the second power transfer tank circuit a second modulated input voltage signal when the first electrical load is connected to the set of first switcher input terminals and the second switcher input terminals are connected to the second electrical power source. The first switcher circuit may be configured for restoring the second input voltage signal shape to a second transmitted voltage signal obtained from the second power transfer tank circuit by modulating the second transmitted voltage signal at the second chopping frequency. The modulating may be square-wave modulating.

The first load circuit may further comprise a transformer electrically connected between the set of second switcher input terminals and the second phase-retarding element. The first and second switcher circuits may comprise discrete semiconductor power switching devices for carrying and modulating the first and second input voltage signals. Each such power-switching device may comprise at least three device terminals. For example, each such device may comprise a power input terminal, a power output terminal, and a control terminal. The first and second switcher circuits may be half-bridge switcher circuits or full-bridge switcher units. The phase-advancing element may be a capacitor. At least one of the first, second, and third phase-retarding elements may comprise an inductor.

According to another aspect, a line frequency bipolar power converter presented for converting AC power in opposing first and second directions through the power converter comprises: a closed loop series reactance network comprising a phase-advancing element and first, second, and third phase-retarding elements all connected in series, a first switcher circuit connected in parallel with the third phase-retarding element and disposed to be selectably connected to one of a first electrical load and a first AC electrical power source providing a first bipolar AC input voltage signal; and a first load circuit connected in parallel with the second phase-retarding element and comprising a second switcher network disposed to be selectably connected to one of a second electrical load and a second AC electrical power source providing a second bipolar AC input voltage signal. When the first switcher circuit is selectably connected to the first power source the second switcher circuit is connected to the second load for power transmission in the first direction; and when the second switcher circuit is selectably connected to the second power source the first switcher circuit is connected to the first load for power transmission in the second direction.

The first and second switcher circuits may be configured for modulating respectively the first input voltage signal and signals derived from the first input voltage signal at a first chopping frequency when the first switcher circuit is selectably connected to the first power source; and the second and first switcher circuits are configured for modulating respectively the second input voltage signal and signals derived from the second input voltage signal at a second chopping frequency when the second switcher circuit is selectably connected to the second power source. The first and second switcher circuits may be configured for modulating at differing phases.

In another embodiment, a line frequency bipolar power converter is provided for converting AC power in opposing first and second directions through the power converter comprising: a closed loop series reactance network comprising a capacitor and first, second, and third phase-retarding elements all connected in series, a first switcher circuit arranged to induce a signal in the third inductor and disposed to be selectably connected to one of a first electrical load and a first AC electrical power source providing a first bipolar AC input voltage signal; and a first load circuit connected across the second phase-retarding element and comprising a second switcher network disposed to be selectably connected to one of a second electrical load and a second AC electrical power source providing a second bipolar input AC voltage signal; wherein: when the first switcher circuit is selectably connected to the first power source the second switcher circuit is connected to the second load for power transmission in the first direction; and when the second switcher circuit is selectably connected to the second power source the first switcher circuit is connected to the first load for power transmission in the second direction.

The power converter may further comprise a common conductor disposed to connect the first AC electrical power source to the second electrical load and the second AC electrical power source to the first electrical load. The first switcher circuit may be arranged to electromagnetically induce a signal in the third inductor via a first 1:1 transformer comprising the third inductor and an inductor connected to the first switcher, the first transformer arranged for a primary of the first transformer to electromagnetically induce in a secondary of the first transformer an equal and opposite voltage. The second switcher circuit may be arranged to electromagnetically induce a signal in the first inductor via a second 1:1 transformer comprising the first inductor and an inductor connected to the first switcher, the second transformer arranged for a primary of the second transformer to electromagnetically induce in a secondary of the second transformer an equal and opposite voltage.

Another aspect provides an AC/AC power converter comprising first and second line terminals for connecting to an AC power line; a closed-loop resonant circuit, first and second switcher circuits and a controller. The closed-loop resonant circuit comprises an input phase-retarding leg and an output phase-retarding leg. A first end of the input phase-retarding leg is connected to a first end of the output phase-retarding leg by a first connecting leg. A second end of the input phase-retarding leg is connected to a second end of the output phase-retarding leg by a second connecting leg. The first and second connecting legs each comprise at least one phase-shifting component. The first switcher circuit is connected between the line terminals and the input leg of the closed loop resonant circuit. The first switcher circuit comprises a plurality of switches controllable between: a first configuration in which a line AC waveform alternating at a line frequency presented between the first and second line terminals is applied across the input leg of the closed loop resonant circuit with a first line polarity; and a second configuration in which the line AC waveform is applied across the input leg of the closed loop resonant circuit with a second line polarity opposite to the first line polarity. The second switcher circuit is connected between the output leg of the closed loop resonant circuit and a load. The second switcher circuit comprising a plurality of switches controllable between: a first configuration in which a chopped AC waveform presented across the output leg of the closed loop resonant circuit is applied across the load with a first chopped waveform polarity; and a second configuration in which the chopped AC waveform is applied across the load with a second chopped waveform polarity opposite to the first chopped waveform polarity. The controller is connected to drive each of the first and second switcher circuits to alternate between their respective first and second configurations at a chopping frequency.

Further aspects of the invention and features of various example embodiments are described below and/or illustrated in the accompanying drawings.

### BRIEF DESCRIPTION OF THE DRAWINGS

Embodiments and applications of the invention are illustrated by the attached non-limiting drawings. The attached drawings are for purposes of illustrating the concepts of the invention and may not be to scale.

FIG. 1 is a schematic circuit showing a single conversion stage bidirectional soft-switched AC/AC power converter employing a full-bridge primary or chopping section and a full-bridge secondary or restoration section according to an example embodiment.

FIG. 2 is a schematic circuit showing a single conversion stage bidirectional soft-switched AC/AC power converter employing a half-bridge primary or chopping section and a half-bridge secondary or restoration section according to an example embodiment.

FIG. 3A shows an equivalent circuit of the example embodiment of FIG. 1 during power transfer from the primary section to the secondary section.

FIG. 3B shows an equivalent circuit of the example embodiment of FIG. 1 during power conversion from the secondary section to the primary section.

FIGS. 4A, 4B, 4C, and 4D show four different example implementations of switcher sub-circuits that may be applied as switches in the single conversion stage bidirectional soft-switched AC/AC power converters of FIG. 1 and FIG. 2.

FIG. 5A is a schematic circuit showing a single conversion stage bidirectional soft-switched AC/AC power converter employing a full-bridge primary or chopping section and a full-bridge secondary or restoration section without a transformer according to an example embodiment.

FIG. 5B is a schematic circuit showing a single conversion stage bidirectional soft-switched AC/AC power converter having no step-up/step-down transformer and having a common conductor connecting an AC power source to an electrical load according to an example embodiment.

FIG. 6 is a flow diagram illustrating an example method for bidirectional power transfer through a single conversion stage bidirectional soft-switched AC/AC resonant power converter according to an example embodiment.

### DETAILED DESCRIPTION

In the following description, certain specific details are set forth in order to provide a thorough understanding of various embodiments of the invention. However, one skilled in the art will understand that the invention may be practiced without these details. In other instances, well-known structures have not been shown or described in detail to avoid unnecessarily obscuring descriptions of the embodiments.

The vast majority of AC loads are reactive. A power converter for supplying AC power to such loads should have bidirectional capabilities to permit interchange of reactive energy between the load and the source. Against the description in the “Background” section of double conversion power converters, it is desirable to have a power converter that improves on the efficiency and/or cost effectiveness of double conversion power converters. As described herein, a line frequency switched mode AC/AC converter built on a single power conversion stage without an intermediate energy storage component can operate so that energy stored in the load reactance can be recovered to the source. That is, the single power conversion stage can provide bidirectional AC power transfer capabilities. A failure to provide a path for interchange of reactive energy from the load to the source may result in load overvoltage in the case of an inductive load or load overcurrent in the case of a capacitive load, with possibly destructive consequences. To address the changing polarity of the AC source, a converter should also be bipolar.

Another challenge in bidirectional power transfer is that of obtaining high efficiency in both directions of conversion. Soft switching of the switching devices is a very effective technique to reduce the switching losses and increase power conversion efficiency, and is discussed in more detail below.

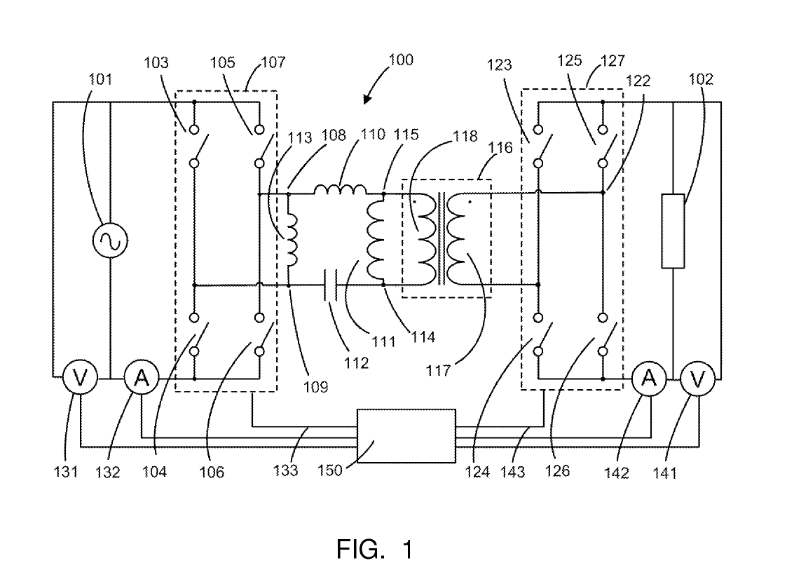

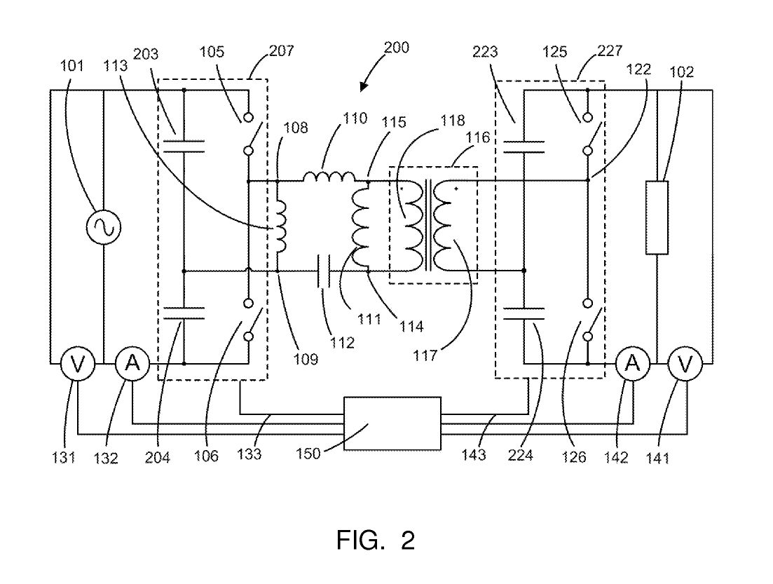

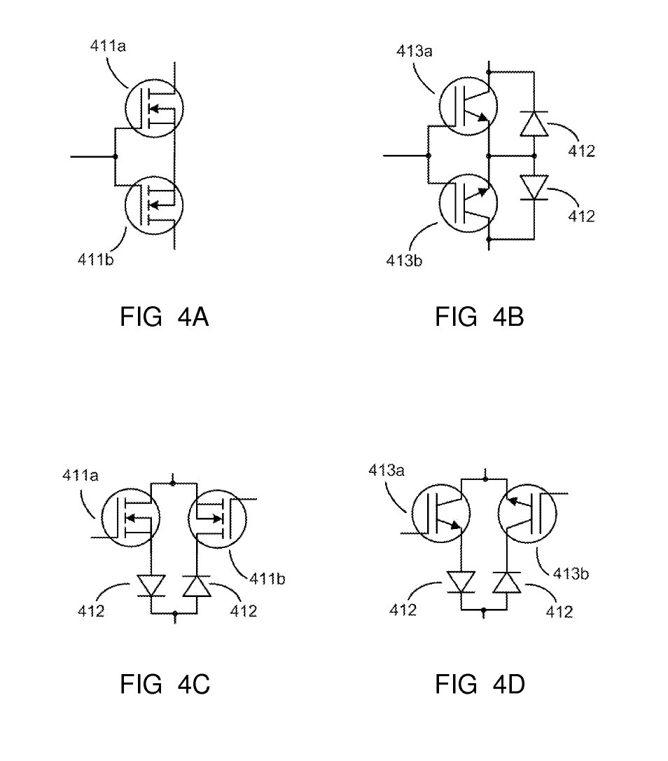

FIG. 1 is a schematic showing a single conversion stage bidirectional soft-switched AC/AC power converter 100 according to an example embodiment. In the case of power transfer from AC source 101 to load 102, a full-bridge switcher circuit 107 comprising controlled switching subcircuits 103, 104, 105, and 106 is connected to AC voltage source 101. The terms “chopper circuit” and “switcher circuit” are employed interchangeably in the present specification. By way of example, AC source 101 may be providing an AC voltage at line frequency, which is usually nominally 50 or 60 Hz, depending on the territory. A full-bridge switcher circuit 127 comprising controlled switching subcircuits 123, 124, 125, and 126 is connected to load 102. Suitable controlled switching devices for use within switching subcircuits 103, 104, 105, 106, 123, 124, 125, and 126 may include by way of non-limiting example MOSFETs, IGBTs, GTOs, and BJTs. FIGS. 4A, 4B, 4C, and 4D show suitable non-limiting example embodiments of switcher subcircuits 103, 104, 105, 106, 123, 124, 125, and 126 in more detail. Such switcher circuits may be built, for example, using standard electronic components as listed at the end of this specification. FIG. 4A, when considered with FIG. 1 and FIG. 2, shows that suitable full-bridge or half-bridge switcher circuits may be employed that have no discrete semiconductor diode devices. In such embodiments, all line power semiconductor switching devices carrying and modulating input power signals in the switcher subcircuits have three or more device terminals.

Switching circuits 103, 104, 105, and 106, are turned on and off with an approximately 50% duty cycle and their switching frequency is controlled to allow full-bridge switcher circuit 107 to produce a square-wave voltage waveform with 50% duty cycle over source circuit terminals 108 and 109. In the present specification, we refer to the frequency at which the input AC voltage is chopped (e.g. by full-bridge switcher circuit 107) as the “chopping frequency”. The chopping frequency may be adjustable. The frequency of the input voltage supplied by AC source 101 is referred to as the “line frequency” in the present specification. Electrical power supplied to the converter for conversion is herein referred to as “electrical line power” and its voltage and current alternate at the line frequency. The chopping frequency is preferably at least 20 times the line frequency, and is more preferably greater than 8 kHz, and most preferably greater than 16 kHz.

In operation, switching circuit 103 and its diagonal partner switching circuit 106 are switched mutually in phase. Switching circuit 104 and its diagonal partner switching circuit 105 are switched mutually in phase. However, the two sets of partner switching circuits are switched 180 degrees out of phase with each other, so that, when switching circuits 103 and 106 are open and non-conducting, then switching circuits 104 and 105 are closed and conducting. This switching arrangement of full-bridge switcher circuit 107 also applies to full-bridge switcher circuit 127, in that switching circuits 123 and 126 are operated mutually in phase and switching circuits 124 and 125 are operated mutually in phase, but the two sets of switcher circuits are operated 180 degrees out of phase. The phase of switching circuit 103 is substantially the same as the phase of switching circuit 123. The duration of the control pulses of all switching devices is substantially half of the switching frequency period. That is, they operate with substantially 50% duty cycle.

A closed loop series reactance network is connected across source circuit terminals 108 and 109 to be driven by the output voltage from full-bridge switcher/chopper circuit 107. The series reactance network comprises three phase-retarding elements, symbolically represented by inductor symbols, and one phase-advancing element, symbolically represented by a capacitor symbol. The mix of phase-retarding and phase-advancing elements renders the series reactance network a resonant network. The term “phase-retarding” is employed in the present specification to describe retarding the phase of the current through the element with respect to the phase of the voltage across the element. By contrast, the term “phase-advancing” is used in the present specification to describe advancing the phase of the current through the element with respect to the phase of the voltage across the element.

A first phase-retarding element 113 is connected across the source circuit terminals 108 and 109 of full-bridge switcher or chopper circuit 107. In one embodiment, phase-retarding element 113 is an inductor, being in this specific case the first inductor of interest. In general, phase-retarding element 113 may be any device or circuit providing suitable phase retardation.

The series reactance network comprises a second phase-retarding element 111 connected across primary 118 of transformer 116, and thereby across load circuit terminals 115 and 114. In general phase-retarding element 111 may be any device or circuit providing suitable phase retardation. In one specific embodiment, second phase-retarding element 111 is an inductor, being in this case the second inductor of interest. Inductor 111 may optionally be embedded in the magnetic structure of transformer 116. The inductance of phase-retarding element 111, often called the “magnetizing inductor”, can be controlled by providing an air gap in the magnetic core and adjusting its length.

The series reactance network further comprises a third phase-retarding element 110 and a phase-advancing element 112. In one embodiment, phase-advancing element 112 is a capacitor. In general phase-advancing element 112 may be any device or circuit providing suitable phase advancement. The third phase-retarding element 110 is connected between the second phase-retarding element 111 and one of source circuit terminals 108 and 109, and the phase-advancing element 112 is connected between the second phase-retarding element 111 and the other of source circuit terminals 108 and 109. In general phase-retarding element 110 may be any device or circuit providing suitable phase retardation. In one embodiment, phase-retarding element 110 is an inductor.

Full-bridge switcher circuit 127 is connected across the secondary 117 of transformer 116, and thereby across load circuit terminals 115 and 114. Switcher circuit 127 is driven at the same chopping frequency with respect to the signal driving switcher circuit 107 to thereby restore the signal produced over load 102 to substantially the same form as that of the signal received by switcher circuit 107 from AC source 101. For this reason, we refer in the present specification to switcher circuit 127, when operated in this configuration, as a “restoration circuit”. In an idealized system that signal shape might very well be sinusoidal, but in practical power systems the signal shape may be distinctly different from sinusoidal. The user, or a suitable controller employed by the user, may control the chopping frequency of the driver control signals for switcher circuits 107 and 127.

In the case of power transfer from the right hand side to left hand side of the circuitry in FIG. 1, the power source and the load effectively exchange their places, i.e. load impedance 102 becomes an AC voltage source, while AC voltage source 101 becomes a load impedance. In addition, the switcher circuit 127 becomes a controlled switcher with controlled switching frequency and approximately 50% duty cycle that produces square-wave voltage with adjustable frequency across the load circuit terminals 115 and 114 of the primary 118 of transformer 116. Furthermore, the full-bridge switcher circuit 107 is now in the role of a restoration circuit and can now be driven at the same frequency as the signal driving switcher circuit 127. This allows the signal produced over element 101, now the load impedance, to be restored to the same form as that of the voltage signal received by switcher circuit 127 from element 102, which is now the AC source.

The above switching arrangement provides a path for any reactive currents to flow from the load 102 to the source 101. These currents are controlled by the controller 150 in a manner ensuring that the voltage produced by the stored energy of the inductive load 102 and reflected to the source side is higher than the voltage across source 101. These currents therefore flow back to the source 101, system 100 thereby fulfilling the requirement of restoring any load reactance energy to the source 101 in a controlled manner.

The series reactance network comprising elements 110, 111, 112, and 113 is employed as a resonant network that may be excited with equal effect across terminals 108 and 109 while loaded across terminals 114 and 115, on the one hand, as when excited across terminals 114 and 115 while loaded across terminals 108 and 109, on the other hand. The difference between these two scenarios is exactly that which pertains when the direction of conversion, as explained above, reverses.

Controller 150 may monitor the operation of a power converter as described herein. In the example embodiments of FIGS. 1 and 2, controller 150 is configured by means of a suitable control algorithm to determine the instantaneous current through source 101 by means of ampere meter 132, the instantaneous current through load 102 by means of ampere meter 142, the instantaneous voltage over source 101 by means of voltmeter 131, and the instantaneous voltage over load 102 by means of voltmeter 131. Controller 150 is further configured by the control algorithm to supply switcher circuits 107 and 127 with respectively first and second chopping signals at the same frequency via respectively chopper control lines 133 and 143. The first and second chopping signals control the gates of the various three-terminal devices in switcher subcircuits 103, 104, 105, 106, 123, 124, 125, and 126, shown in more detail in FIG. 4a, FIG. 4b, FIG. 4c, and FIG. 4d.

Controller 150 may have, stored within a suitable memory, reference values for the source and load currents and for the source and load voltages. The controller 150 may also maintain internal sinusoids, or any other desired waveforms, synchronized with the zero crossings in the load current and load voltage, and it may use these waveforms as reference waveforms to be followed by the voltage and/or current of the power being transferred. Since the chopping frequency is much higher than the AC line frequency, the line current and voltage signal shapes may be adjusted very rapidly within one AC line voltage cycle.

In some embodiments, a controller 150 monitors a voltage being delivered across the load and compares the monitored voltage to a reference value. The reference value may be time-varying. For example, the reference value may vary according to a desired output waveform. Controller 150 may select the reference value to compare to the monitored voltage at the current time by tracking a phase of the output AC waveform being applied across the load. In response to the comparison, controller 150 may control the chopper frequency. If the monitored voltage exceeds the reference value controller 150 may increase the chopper frequency. Conversely, if the monitored voltage is below the reference value controller 150 may decrease the chopper frequency. In some embodiments, the amount of increase or decrease of the chopper frequency is variable and is selected based on a magnitude of the difference between the monitored voltage and the current reference value. Such controllers 150 may be applied to drive any of the embodiments disclosed herein.

With a controller 150 operating as described above, electrical power may flow from source to load. However, where the load is a reactive load, energy can also flow in the reverse direction, from load to source, during portions of a cycle of the AC line voltage. This reverse flow of energy can be regulated by controller 150 which varies the chopper frequency in real time to maintain the voltage delivered to the load according to a desired waveform.

In the embodiment illustrated in FIG. 1, during energy transfer from left to right, controller 150 measures the instantaneous current through load 102 by means of ampere meter 142 and the instantaneous voltage over load 102 by means of voltmeter 141 as well as the instantaneous current through source 101 as measured by ampere meter 132 and the instantaneous voltage over source 101 as measured by voltmeter 131. It then adjusts the frequency of the first and second chopping signals, ensuring that the current through the switches lags the voltage across the switches. It also ensures that the load voltage follows the reference waveform stored in the controller, and that the load current does not exceed the reference value stored in the controller.

The phase of the current signal through switching pairs 103, 106 and 104, 105 of the switcher 107 lags the phase of the voltage produced across these switching pairs at frequencies above a certain minimum chopping frequency. This is the condition to be satisfied in order to provide substantially lossless soft-switching. This minimum chopping frequency is determined by the detailed choice of component values of elements 111, 110, and 112, and is distinctly higher than the resonance frequency of the resonant circuit. At or near the minimum chopping frequency, the voltage across the load 102 is at a maximum.

At chopping frequencies greater than this minimum chopping frequency, the converter is in the soft-switching range where substantially lossless power conversion may be maintained over a wide chopping frequency range. As the chopping frequency is increased above the minimum chopping frequency, the phase lag of the current through the switching pairs 103, 106 and 104, 105 with respect the voltage across the switching pairs 103, 106 and 104, 105 monotonically increases, while the voltage across the load 102 monotonically decreases.

When power is transferred in the reverse direction through the system 100, the minimum chopping frequency is determined by the detailed choice of component values of elements 113, 110, and 112. Since, for reverse transfer of power, element 113 replaces element 111 in the determination of the minimum chopping frequency, the corresponding minimum chopping frequency is different from the value of the minimum chopping frequency for the forward power transfer configuration. As a result, the chopper frequencies will almost always differ for forward and reverse power transfer, but may under some circumstances be the same. During this reverse transfer, controller 150 adjusts the chopping frequency on the basis of the instantaneous current through source 101 as measured by ampere meter 132, the instantaneous current through load 102 as measured by means of ampere meter 142 and the instantaneous voltage over load 102 as measured by means of voltmeter 141. More specifically, it adjusts the frequency of the first and second chopping signals, ensuring that the current through the switches lags the voltage across the switches. It also ensures that the load voltage follows the reference waveform stored in the controller.

FIG. 2 shows an alternative embodiment of a single conversion stage bidirectional soft-switched AC/AC power converter in the form of converter 200. Elements numbered the same as in FIG. 1 are similar types of elements, though their precise values may differ from the identically numbered elements in FIG. 1. Converter 200 differs from converter 100 of FIG. 1. Switching circuits 103, 104, 123 and 124 have all been replaced by capacitors, thereby making switcher/chopper circuit 207 and switcher/restoration circuit 227 half-bridge switchers. Other detailed arrangements of electronic switching circuits for switchers 107, 127, 207, and 227, are contemplated by the inventors, all such switching circuits ensuring that the chopper circuit and the restoration circuit in a given converter operate as synchronous phase controlled switches.

In other embodiments employing the same elements as in FIG. 1, switcher circuit 107 may be connected over terminals 108 and 115 instead of terminals 108 and 109 of the closed loop series reactance network. Similarly, yet further embodiments employing the same elements as FIG. 2 allow switcher circuit 207 to be connected over terminals 108 and 115 instead of terminals 108 and 109. The distinction is merely in which of phase-retarding elements 110 and 113 spans the input terminals to the series reactance network.

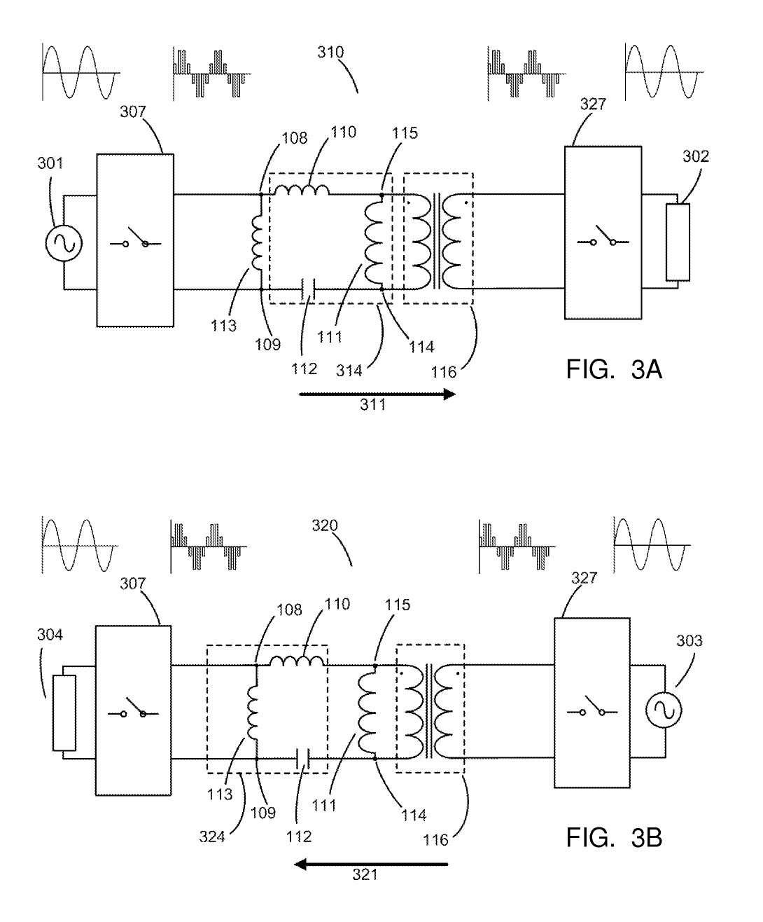

Returning to FIG. 1 as example, the interchanging of the functions of the switcher circuits 107 and 127 when the source and the load exchange places is schematically illustrated in FIG. 3A and FIG. 3B. These two figures are simplified versions of converters as illustrated in FIG. 1 and FIG. 2 during respectively power transfer from left to right (FIG. 3A), and from the right to left (FIG. 3B) through the bidirectional converter. In selecting components for such a design, it is found that for high efficiency power transfer the inductance of phase-retarding element 111 is typically larger than the inductance of phase-retarding element 110.

FIG. 3A and FIG. 3B represent equivalent circuits of AC/AC power converter 100 when operated in two different modes, representing opposing power transfer directions. In converter 310 of FIG. 3A the power transfer is from the left to right along a first direction 311 in a first power transfer mode through bidirectional converter 100 configured as left-to-right power converter 310, while in converter 320 of FIG. 3B the power transfer is from the right to the left along an opposing second direction 321 in a second power transfer mode through bidirectional converter 100 configured as right-to-left power converter 320. FIGS. 3A and 3B may be applied exactly the same way to converter 200 of FIG. 2. All elements in FIG. 3A and FIG. 3B numbered the same as in FIG. 1 and FIG. 2 are the same types of elements, but may have different values.

As shown in each of FIGS. 3A and 3B the electronic circuit includes terminals 114 and 115 and the series reactance network which comprises reactance elements 110, 111, 112, 113. Phase-retarding element 111 is connected across a first set of resonant circuit terminals 115 and 114, while phase-retarding element 113 is connected across a second set of resonant circuit terminals 108 and 109. Phase-advancing element 112 and third phase-retarding element 110 are connected in series with the primary side of transformer 116 while second phase-retarding element 111 is connected in parallel with the primary side of transformer 116.

In the first power transfer mode shown in FIG. 3A and being along direction 311, a first load circuit restoration circuit 327 and transformer 116 are connected across terminals 115 and 114. In FIG. 3, restoration circuit 327 can be either restoration circuit 127 of FIG. 1 or restoration circuit 227 of FIG. 2, or any other restoration/switcher circuit that conforms to the requirements described herein. In the first power transfer mode, phase-advancing element 112 and third phase-retarding element 110 are connected in series with the first load circuit, while the second phase-retarding element 111 is connected in parallel with the first load circuit. The shapes of voltage signals at the various stages of the converter are shown above the circuit in FIG. 3A.

In a second transfer mode, shown in FIG. 3B and being along direction 321, a second load circuit comprising switcher circuit 307 is connected across terminals 108 and 109. In FIG. 3B, switcher circuit 307 can be either switcher circuit 107 of FIG. 1 or switcher circuit 207 of FIG. 2, or any other switcher circuit that conforms to the restoration circuit requirements described herein. In the second power transfer mode, phase-advancing element 112 and third phase-retarding element 110 are connected in series with the second load circuit, while the first phase-retarding element 113 is connected in parallel with the second load circuit. The shapes of signals at the various stages of the converter are shown above the circuit in FIG. 3B.

The resonant circuit in FIG. 3A and FIG. 3B is of the same type for both directions of power transfer, and it performs the same role for both directions of power transfer. For example, with the load section connected across phase-retarding element 111 in FIG. 3A, the resonant components involved in the power transfer and which therefore determine the voltage gain of the converter 310 (i.e. the ratio between the output voltage and the input voltage) are phase-retarding elements 110 and 111 together with phase-advancing element 112. Phase-retarding element 113 is connected directly across the output terminals of the chopper circuit 307 and therefore it does not take part in power transfer. That is, element 113 does not affect the voltage gain characteristics of the resonant circuit. Accordingly, a first power transfer tank circuit 314, comprising phase-retarding elements 110 and 111 together with phase-advancing element 112, is provided by the electronic circuit of FIG. 3A.

With the load section connected across phase-retarding element 113 in FIG. 3B, the resonant components involved in the power transfer and which therefore determine the voltage gain of the converter 310 (i.e. the ratio between the output voltage and the input voltage) are phase-retarding elements 110 and 113 together with phase-advancing element 112. Phase-retarding element 111 is effectively connected across the output terminals of the chopper circuit 327 via the transformer 116 and therefore it does not take part in power transfer. That is, element 111 does not affect the voltage gain characteristics of the resonant circuit. Accordingly, a second power transfer tank circuit 324, comprising phase-retarding elements 110 and 113 together with phase-advancing element 112, is provided by the electronic circuit of FIG. 3B.

This very desirable equality of the resonant configurations in both directions of the power transfer is due to phase-retarding element 113. In this example embodiment, phase-retarding element 113 is implemented as an external component. First power transfer tank circuit 314 has the same structural resonant configuration as second power transfer tank circuit 324, phase-retarding element 111 of first power transfer tank circuit 314 being replaced by phase-retarding element 113 of second power transfer tank circuit 324. That is, the combination of reactance elements employed by the first power transfer tank circuit 314 has the same structural resonant configuration as the combination of reactance elements employed by the second power transfer tank circuit 324.

To maintain the desirable characteristics of converter 310 in the opposing direction of power conversion, circuits such as those shown in FIGS. 1, 2, 3A, and 3B provide the same resonant configuration in both directions of power conversion. Referring back to FIG. 3A and FIG. 3B, which represent a simplified version of the circuits of FIG. 1 and FIG. 2, during both directions of power transfer, the phase-retarding element 113 advantageously provides desired symmetry of both of the resonant configurations.

Phase-retarding element 113 in the example embodiment of FIG. 1 makes the resonant configurations symmetrical in both directions of power transfer resulting in step-down/step-up voltage conversion that can be accompanied by substantially loss-less ZVS/ZCS operation in both directions of power conversion. The exact values of resonant characteristics in both directions of power transfer are governed by the ratios of the inductances of phase-retarding elements 111 and 113 to the inductance value of phase-retarding element 110. In an example case the turns ratio of transformer 116 is 1:1, phase-retarding elements 111 and 113 are equal and the input/output terminals of the circuit are equally loaded (during the bidirectional transfer). Under these circumstances bidirectional converter 100 will exhibit exactly the same DC-voltage gain and ZVS/ZSC characteristics in both directions of power transfer.

It is to be noted that in some example embodiments, various ones of the corresponding resonant components employed to establish symmetrical resonant configurations in both directions of power transfer have different values. In some example embodiments, a value of a resonant component employed in a first resonant circuit is different from a value of a corresponding resonant component employed by a second resonant circuit that has the same resonant configuration as the first resonant circuit. In other embodiments, resonant circuits having different resonant configurations may be employed in each direction of power transfer. However, the frequency of chopper/switcher circuits is adjustable and fully under the control of the user, or a suitable controller provided by the user. It is therefore possible to program such a controller to adjust the frequency to ensure substantially lossless conversion in both directions through the circuits of FIG. 1 and FIG. 2, based on the principles explained with reference to FIG. 3A and FIG. 3B.

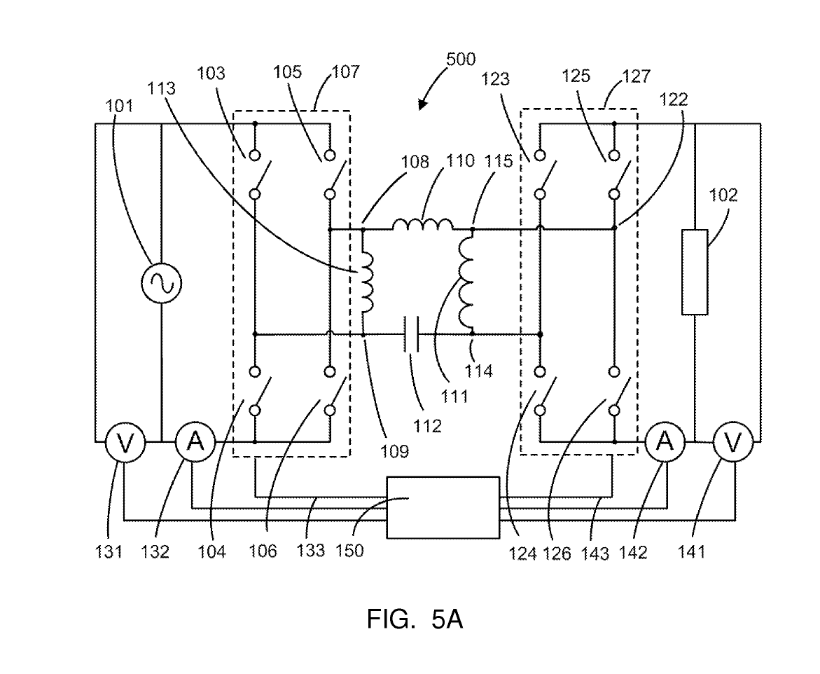

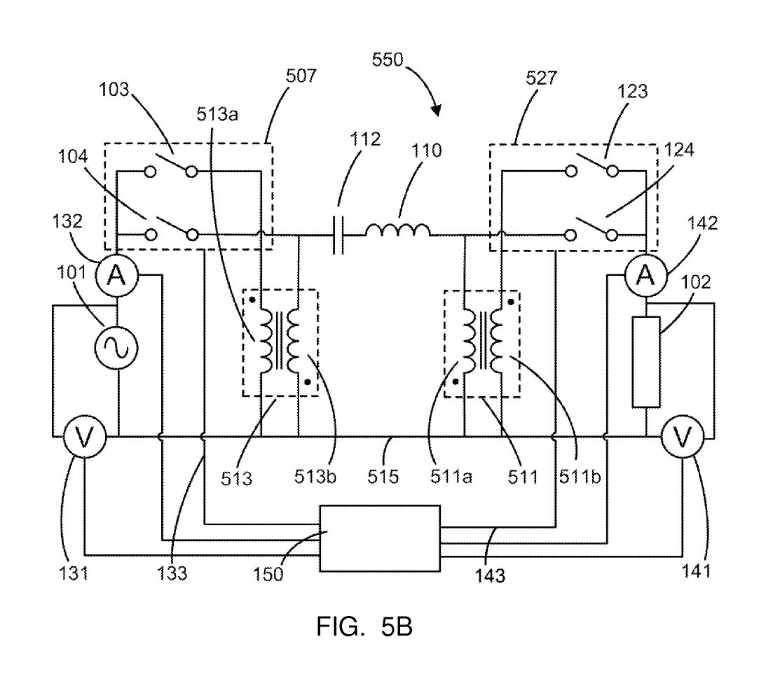

FIG. 5A shows a single conversion stage bidirectional soft-switched resonant AC/AC power converter according to another example embodiment. The converter is based on components and elements identical to those of FIG. 1, with the difference that transformer 116 of FIG. 1 is absent. The first load circuit in this case comprises switcher circuit 127. To the extent that the resonant circuit comprising reactance elements 110, 111, 112, and 113 can have greater than unity voltage gain, as measured between the voltage across element 111 relative to the voltage across element 113, the circuit of FIG. 5 may be employed as a bidirectional soft switching resonant voltage converter in situations where a transformer is not desired or not appropriate. The converter may be operated the same way as that in FIG. 1, except that the chopping frequencies required to achieve desired voltages required for suitable signal restoration in the switcher/chopper circuits will be different from those in FIG. 1. The voltage converter of FIG. 1 may in fact be viewed as the converter of FIG. 5A with an additional transformer 116 to achieve larger step-up voltages or smaller step-down voltages. The matter of non-unity voltage gain in resonant circuits of this general type is described in more detail in U.S. Pat. No. 8,363,427 B2 by Petkov et al, the specification of which is hereby incorporated by reference in full in the present specification for all purposes.

FIG. 5B shows a single conversion stage bidirectional soft-switched resonant AC/AC power converter 550 according to another example embodiment that does not employ a step-up/step-down transformer. Elements identically numbered to elements in FIG. 5A are of the same type as in FIG. 5A, but have their own operational specifications and values, including, for example, their reactances. First center tap switcher circuit 507, comprising switching subcircuits 103 and 104, drives phase-retarding element 513b, either directly via switching subcircuit 104 or indirectly via switching subcircuit 103. Switching subcircuit 104 modulates the signal from power source 101 to a chopping frequency. The resulting signal is connected to the closed loop series reactance network comprising phase-advancing element 112 and phase-retarding elements 513b, 110, and 511a.

Switching subcircuit 103, in its turn, is connected to phase-retarding element 513a. Phase-retarding elements 513a and 513b, in the form of two inductors, may together form a 1:1 transformer 513 in which inductors 513a and 513b are mutually disposed and arranged to electromagnetically induce mutually opposed voltages as shown in FIG. 5b. This arrangement allows inductor 513a to induce a voltage equal and opposite to its own voltage in inductor 513b.

In this embodiment, at least one of switching subcircuits 103 and 104 is at any moment in time driving the power transfer tank circuit formed by reactance elements 112, 110 and 511a, while all the stages of the system as a whole maintain a single unbroken common line 515, shown at the bottom of FIG. 5B. This allows the system to conform to various safety standards.

At the output side of system 550 of FIG. 5B, second center tap switcher circuit 527 either takes its input directly across reactance element 511a under the action of switcher subcircuit 124, or by means of induction from reactance element 511a via reactance element 511b under the action of switcher subcircuit 123. Phase-retarding elements 511a and 511b, in the form of two inductors, may together form a 1:1 transformer 511 in which inductors 511a and 511b are mutually disposed and arranged to electromagnetically induce mutually opposed voltages as shown in FIG. 5b. This arrangement allows inductor 511a to induce a voltage equal and opposite to its own voltage in inductor 511b.

As in the foregoing embodiments, the power signal from source 101 is modulated at a first chopping frequency by switcher circuit 507 and supplied to the first power transfer tank circuit comprising elements 112, 113 and 511a. From there the signal tapped over element 511a is transferred to switcher circuit 527, directly or indirectly, where the signal shape of the signal from source 101 is restored to the output signal of the power transfer tank by suitable modulation at the first chopping frequency. This restored signal is then supplied to load 102.

For power transfer in the reverse direction, system 550 is electronically symmetrical in its structure, the order of elements 112 and 110 being immaterial to the working of the system 550. In this case, load 102 is replaced by a source that provides a second input power signal, switcher circuit 527 does the modulation of this second input power signal at a second chopping frequency. The second chopping frequency will usually be different from the first chopping frequency, but may under some circumstances be the same as the first chopping frequency. The power is transmitted via a second power transfer tank circuit defined by elements 110, 112, and 513b. Switcher circuit 507 in this case then restores the shape of the second input signal to the power signal transmitted over the second power transfer tank circuit. In this reverse power transfer, element 511b induces an equal and opposite voltage in element 511a and element 513b induces an equal and opposite voltage in element 513a.

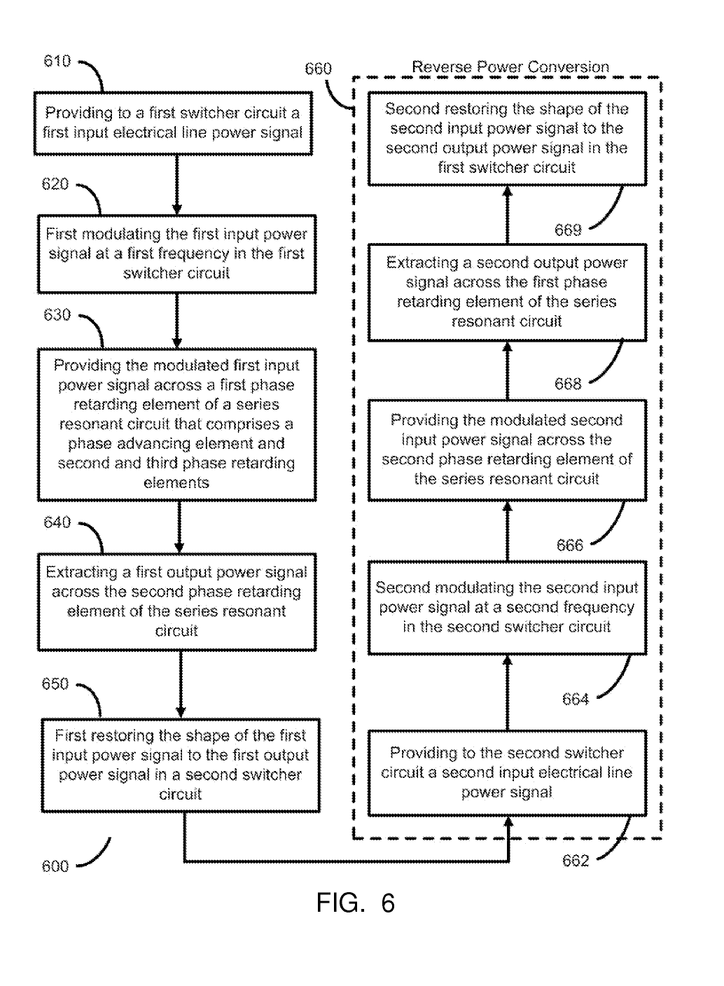

In a further aspect, illustrated by the flow chart of FIG. 6, a method 600 is provided for transferring electrical line power along opposing first and second paths through a closed loop series reactance network comprising first, second, and third phase-retarding elements and a phase-advancing element. The method comprises: providing 610 to a first switcher circuit (e.g. switcher circuit 107 of FIG. 1) a first input AC electrical line voltage signal having a first input voltage signal shape; first modulating 620 the first input voltage signal at a first chopping frequency in the first switcher circuit 107; providing 630 to a first set of terminals (e.g. terminals 108 and 109 across the first phase-retarding element 113 of the series reactance network) a first modulated input voltage signal from the first switcher circuit 107; extracting 640 from a second set of terminals (e.g. terminals 114 and 115 across the second phase-retarding element 111 of the series reactance network) a first modulated resonator output voltage signal; first restoring 650 in a second switcher circuit (e.g. switcher circuit 127) the first input voltage signal shape to the first modulated resonator output voltage signal to create a first restored output voltage signal; and reversing 660 power transfer through the series reactance network. In the present specification the phrase “first modulated resonator output voltage signal” is used to describe the voltage signal taken directly from terminals 114 and 115 on the closed loop reactance network or the signal indirectly taken from the closed loop reactance network through transformer 116.

Reversing 660 the power transfer through the closed loop series reactance network comprises providing 662 to the second switcher circuit 127 a second input AC electrical line voltage signal having a second input voltage signal shape; second modulating 664 the second input voltage signal at a second chopping frequency in the second switcher circuit 127; providing 666 to the second set of terminals 114 and 115 across the second phase-retarding element 111 of the resonant circuit a second modulated input voltage signal from the second switcher circuit 127; extracting 668 from the first set of terminals 108 and 109 across the first phase-retarding element 113 of the series reactance network a second modulated resonator output voltage signal; second restoring 669 in the first switcher circuit 107 the second input voltage signal shape to the second modulated resonator output signal to create a second restored output voltage signal. The providing 666 a second modulated input voltage signal from the second switcher circuit may be directly from the second switcher circuit 127 or may be indirectly via the transformer 116.

Changes in the chopping frequency may alter the direction of the net flow of power through the closed loop reactance network. In some embodiments of method 600 the chopping frequency is varied continuously or nearly continuously. The chopping frequency may be set based on parameters (e.g. monitored voltages and/or currents) of the closed loop reactance network. The chopping frequency may be changed a plurality of times in a cycle or half-cycle of the line frequency. In some embodiments the chopping frequency is set to provide power transfer in a forward direction (from a source to a reactive load) during a first part of a half-cycle at the line frequency and is set to provide transfer of reactive power from the reactive load back to the source in a later part of the half-cycle while maintaining a net power flow in the forward direction over a full cycle at the line frequency.

The first and second frequencies are preferably at least twenty times as high as a frequency of the electrical line voltage, preferably at least 8 kHz, and most preferably at least 16 kHz. The first restoring 650 comprises third modulating the first output voltage signal at the first chopping frequency. The second restoring [669] comprises fourth modulating the second output voltage signal at the second chopping frequency. The first, second, third, and fourth modulating may comprise square wave modulating or chopping.

The first and second restoring further respectively comprise transferring the electrical power in opposing directions 311 and 321 of FIG. 3A and FIG. 3B respectively along a segment of the series reactance network comprising the third phase-retarding element and the phase-advancing element separated from the third phase-retarding element by the first and second phase-retarding elements. As already described, in some embodiments, the various phase-retarding elements may be inductors and the phase-advancing element may be a capacitor.

The method may perform step-up-transformerless power conversion (using apparatus as shown, for example, in FIGS. 5A and 5B). The step-up-transformerless power conversion may comprise maintaining a single common voltage line between source 101 and load 102. The maintaining a single common voltage line between source and load may comprise modulating an input voltage signal in a center tap switcher circuit 507, 527. The maintaining a single common voltage line between source 101 and load 102 may comprise transferring power into a first and second power transfer tank circuits, comprising elements 112, 110, and 511a on the one hand and elements 110, 112, and 513b on the other, by 1:1 reverse polarity inducing of a voltage in a reactance element of the closed loop series reactance network consisting of elements 513b, 112, 110, and 511a. For example, for the forward transfer of power when switcher subcircuit 103 is conductive, the inducing is into element 513b and 511b. In the reverse transfer direction, when switcher subcircuit 123 is conductive, the inducing is into elements 511a and 513a.

Referring back to FIGS. 3A and 3B, it is to be noted that costs are advantageously reduced in this example embodiment since the first power transfer tank circuit 314 shares at least two common resonant components with the second power transfer tank circuit 324. These are third phase-retarding element 110 and phase-advancing element 112. Each of the first and second power transfer tank circuits 314 and 324 includes only a single different component. Specifically, the first power transfer tank circuit 314 includes a first resonant component, being phase-retarding element 111 that is different from a second resonant component, being phase-retarding element 113 employed by the second power transfer tank circuit 324. While different example embodiments are contemplated for the circuitry surrounding the series reactance network, the first power transfer tank circuit 314 in forward transfer and the second power transfer tank circuit 324 in reverse transfer through the same converter always have at least one phase-advancing element and one phase-retarding element in common.

Series type bidirectional line frequency AC/AC resonant converters as described in the present specification may be designed to provide a wide range of output voltage controllability in both directions of power transfer. Such circuits can provide, when needed, galvanic isolation between the power source and the load. By employing the same components for power conversion in both directions of power transfer, some embodiments can be very cost effective. The resonant converter of the present specification also provides for substantially loss-less switching operation in both directions of power transfer over the whole range of load conditions, from no load to full load, and substantially loss-less switching operation for all semiconductor devices in the circuitry.

Example applications of bidirectional line frequency AC/AC resonant converter 100, 200, 500, 550 described in this specification include switched mode distribution transformers that step down, for example, the medium transmission voltage (from 2 kV to 35 kV) from suburban power distribution substations to 120V/208/240V required by ordinary households. Present transformers operate at mains frequency and are bulky, heavy and uncontrollable. They are also becoming more and more expensive due to the constantly increasing price of the raw materials used. The bidirectional line frequency AC/AC resonant converter described in this specification is much smaller and lighter, and has comparable power efficiency. The main advantage of the power converter described here is its controllability. Power converters as described herein may be incorporated into so-called “smart” grids and may be individually controlled/monitored from a remote location.

Bidirectional line frequency AC/AC resonant converters as described in the present specification may also be employed to replace step-down power supplied for electronic equipment such as, for example, current cable television power supplies. Present cable television power supplies are essentially ferro-resonant step-down transformers powered from the 120V/208/240V mains supply. They produce trapezoidal output voltage to power cable TV equipment. These operate at relatively low power efficiencies of approximately 85%. In addition they are big and heavy and are becoming ever more expensive. Bidirectional line frequency AC/AC resonant converters as described in the present specification can operate with 98% efficiency and produce the trapezoidal output voltage needed in much smaller/lighter package. It may also be produced at lower unit cost.

The various embodiments described herein can be combined or modified to provide other example embodiments. The scope of the invention is to be construed in accordance with the substance defined by the following claims. As will be apparent to those skilled in the art in light of the foregoing disclosure, many alterations and modifications to the above-described embodiments are possible. For example, certain modifications, permutations, additions and sub-combinations of the features described herein will be apparent to those skilled in the art. It is intended that the following appended claims and the claims hereafter introduced should be interpreted broadly so as to encompass all such modifications, permutations, additions and sub-combinations as are consistent with the language of the claims, broadly construed.

### INTERPRETATION OF TERMS

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Controllers for converters as described herein may be implemented using, as a controller, specifically designed hardware, configurable hardware, programmable data processors configured by the provision of software (which may optionally comprise “firmware”) capable of executing on the data processors, special purpose computers and/or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, and the like. For example, one or more data processors in a controller for a device may implement methods as described herein by executing software instructions in a program memory accessible to the processors.

In examples where processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The invention may also be provided in the form of a program product. The program product may comprise any non-transitory medium which carries a set of computer-readable instructions which, when executed by a data processor, cause the data processor to execute or control a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a circuit, component, software module, processor, assembly, device, switch, transformer, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

### LIST OF REFERENCES

100 single conversion stage bidirectional soft-switched AC/AC power converter
101 alternating current (AC) source
102 load
103 switching subcircuit
104 switching subcircuit
105 switching subcircuit
106 switching subcircuit
107 full-bridge switcher circuit
108 terminal
109 terminal
110 phase-retarding element
111 phase-retarding element
112 phase-advancing element
113 phase-retarding element
114 terminal
115 terminal
116 transformer
117 transformer secondary
118 transformer primary
123 switching subcircuit
124 switching subcircuit
125 switching subcircuit
126 switching subcircuit
127 full-bridge switcher circuit
131 voltmeter
132 ampere meter
133 chopper control line
141 voltmeter
142 ampere meter
143 chopper control line
150 controller
200 single conversion stage bidirectional soft-switched AC/AC power converter
203 capacitor
204 capacitor
207 half-bridge switcher circuit
223 capacitor
224 capacitor
227 half-bridge switcher circuit
301 alternating current (AC) source
302 load
303 alternating current (AC) source
304 load
307 switcher circuit
310 single conversion stage bidirectional soft-switched AC/AC power converter
operated in forward direction
311 first direction of power transfer
314 power transfer tank circuit
320 single conversion stage bidirectional soft-switched AC/AC power converter operated in reverse direction
321 second direction of power transfer
324 power transfer tank circuit
327 switcher circuit
411a MOSFET enhanced mode (Metal Oxide Field Effect Transistor)
411b MOSFET enhanced mode (Metal Oxide Field Effect Transistor)
412 rectifying diode
413a IGBT (Insulated Gate Bipolar Transistor)
413b IGBT (Insulated Gate Bipolar Transistor)
500 single conversion stage bidirectional soft-switched AC/AC power converter without transformer
507 switcher circuit
511 1:1 transformer with primary and secondary coils arranged for opposing voltage induction
511a Phase-retarding element and inductor
511b Phase-retarding element and inductor magnetically connected to 511a
513 1:1 transformer with primary and secondary coils arranged for opposing voltage induction
513a Phase-retarding element and inductor
513b Phase-retarding element and inductor magnetically connected to 513a
515 Common line shared by the source and the load
527 switcher circuit
550 single conversion stage bidirectional soft-switched AC/AC power converter without step-up transformer and having a common conductor between source and load
600 Method for transferring electrical line power along opposing first and second paths through a closed loop series reactance network
610 Providing to a first switcher circuit a first input electrical line voltage signal
620 First modulating the first input voltage signal at a first frequency in the first switcher circuit
630 Providing the modulated first input voltage signal across a first phase-retarding element of a series resonant circuit that comprises a phase-advancing element and second and third phase-retarding elements
640 Extracting a first output voltage signal across the second phase-retarding element of the series resonant circuit
650 First restoring the shape of the first input voltage signal to the first output voltage signal in a second switcher circuit
660 The reversing power transfer through the closed loop series reactance network
662 Providing to the second switcher circuit a second input electrical line voltage signal
664 Second modulating the second input voltage signal at a second frequency in the second switcher circuit
666 Providing the modulated second input voltage signal across the second phase-retarding element of the series resonant circuit
668 Extracting a second output voltage signal across the first phase-retarding element of the series resonant circuit
669 Second restoring the shape of the second input voltage signal to the second output power signal in the first switcher circuit

1. A method for transferring electrical line power along opposing first and second paths through a closed loop series reactance network comprised of first, second, and third phase-retarding elements and a phase-advancing element, the method comprising:
a. providing to a first switcher circuit a first input bipolar AC electrical line voltage signal having a first input signal shape;
b. first modulating the first input bipolar voltage signal at a first chopping frequency in the first switcher circuit;
c. providing across the first phase-retarding element a first modulated input voltage signal from the first switcher circuit;
d. extracting across the second phase-retarding element a first modulated resonator output voltage signal; and
e. first restoring in a second switcher circuit the first input signal shape to the first modulated resonator output voltage signal to create a first restored output signal.

2. The method of claim 1, further comprising reversing power transfer through the closed loop series reactance network.

3. The method of claim 2, wherein the reversing the power transfer comprises:
a. providing to the second switcher circuit a second input bipolar AC electrical line voltage signal having a second input signal shape;
b. third modulating the second input bipolar voltage signal at a second chopping frequency in the second switcher circuit;
c. providing across the second phase-retarding element a second modulated input voltage signal from the second switcher circuit;
d. extracting across the first phase-retarding element a second modulated resonator output voltage signal; and
e. second restoring in the first switcher circuit the second input signal shape to the second modulated resonator output voltage signal to create a second restored output voltage signal.

4. The method of claim 3, wherein the second restoring comprises fourth modulating the second output voltage signal at the second chopping frequency.

5. The method of claim 4, wherein the second and fourth modulating comprise square wave modulating.

6. The method of claim 3, wherein the providing the second modulated input voltage signal comprises providing the second modulated input power signal through a transformer.

7. The method of claim 3, wherein the providing the second modulated input voltage signal comprises inducing the first modulated input voltage signal in the second phase-retarding element.

8. The method of claim 7, further comprising supplying the second restored output voltage signal to a load connected to a source of the second input bipolar voltage signal by a common conductor.

9. The method of claim 7, wherein the inducing comprises inducing the second modulated input voltage signal through a 1:1 transformer arranged to induce from a primary of the transformer into a secondary of the transformer an equal and opposite voltage signal.

10. The method of claim 3, wherein the first and second chopping frequencies are at least twenty times the frequencies of the first and second line voltage signals.

11. The method of claim 1, wherein the first restoring comprises second modulating the first output voltage signal at the first chopping frequency.

12. The method of claim 1, wherein the extracting the first modulated resonator output voltage signal comprises extracting the first modulated resonator output voltage signal through a transformer.

13. The method of claim 1, wherein providing the first modulated input voltage signal comprises inducing the first modulated input voltage signal in the first phase-retarding element.

14. The method of claim 13, further comprising supplying the first restored output voltage signal to a load connected to a source of the first input bipolar voltage signal by a common conductor.

15. The method of claim 13, wherein the inducing comprises inducing the first modulated input voltage signal through a 1:1 transformer arranged to induce from a primary of the transformer into a secondary of the transformer a signal of equal and opposite voltage.

16. An AC to AC line frequency bipolar power converter comprising:
a. a closed loop series reactance network comprising a phase-advancing element and first, second, and third phase-retarding elements all connected in series;
b. a first power transfer tank circuit comprising the phase-advancing element, the first phase-retarding element, and the second phase-retarding element;
c. a second power transfer tank circuit comprising the phase-advancing element, the first phase-retarding element, and the third phase-retarding element;
d. a first switcher circuit connected over the third phase-retarding element and over the first power transfer tank circuit; and
e. a first load circuit connected over the second phase-retarding element and over with the second power transfer tank circuit.

17. The power converter of claim 16, wherein the first switcher circuit comprises a set of first switcher input terminals disposed for selectably connecting to one of
a. a first electrical load; and
b. a first electrical power source providing a first input bipolar AC electrical line voltage signal having a first input signal shape.

18. The power converter of claim 17, wherein the first load circuit comprises a second switcher circuit, the second switcher circuit comprising:
a. a set of second switcher input terminals; and
b. a set of second switcher output terminals disposed and configured to connect selectably to one of a second electrical load and a second electrical power source providing a second input bipolar AC electrical line voltage signal having a second input signal shape.

19. The power converter of claim 18, wherein the first switcher circuit is configured for modulating at a first chopping frequency the first bipolar input line voltage signal to provide to the first power transfer tank circuit a first modulated input voltage signal when the second electrical load is connected to the set of second switcher output terminals and the first switcher input terminals are connected to the first electrical power source.

20. The power converter of claim 19, wherein the second switcher circuit is configured for restoring the first input signal shape to a first transmitted voltage signal obtained from the first power transfer tank circuit.

21. The power converter of claim 20, wherein the second switcher circuit is configured for restoring the first input signal shape to a first transmitted voltage signal by modulating at the first chopping frequency the first transmitted voltage signal.

22. The power converter of claim 21, wherein the first switcher circuit is configured for square-wave modulating the first line voltage signal at the first chopping frequency.

23. The power converter of claim 19, wherein the first chopping frequency is at least twenty times a frequency of the first line voltage signal.

24. The power converter of claim 18, wherein the second switcher circuit is configured for modulating at a second chopping frequency the second line voltage signal to provide to the second power transfer tank circuit a second modulated input voltage signal when the first electrical load is connected to the set of first switcher input terminals and the second switcher input terminals are connected to the second electrical power source.

25. The power converter of claim 24, wherein the first switcher circuit is configured for restoring the second input signal shape to a second transmitted voltage signal obtained from the second power transfer tank circuit by modulating at the second chopping frequency the second transmitted power signal.

26. The power converter of claim 18, wherein the first load circuit further comprises a transformer electrically connected between the set of second switcher input terminals and the second phase-retarding element.

27. The power converter of claim 18, wherein the first and second switcher circuits comprise discrete semiconductor power switching devices connected to carry and modulate the first and second input voltage signals.

28. An AC/AC power converter comprising:
first and second line terminals for connecting to an AC power line;
a closed-loop resonant circuit comprising an input phase-retarding leg and an output phase-retarding leg, a first end of the input phase-retarding leg connected to a first end of the output phase-retarding leg by a first connecting leg, a second end of the input phase-retarding leg connected to a second end of the output phase-retarding leg by a second connecting leg, the first and second connecting legs each comprising at least one phase-shifting component;
a first switcher circuit connected between the line terminals and the input leg of the closed loop resonant circuit, the first switcher circuit comprising a plurality of switches controllable between:
a first configuration in which a line AC waveform alternating at a line frequency presented between the first and second line terminals is applied across the input leg of the closed loop resonant circuit with a first line polarity; and
a second configuration in which the line AC waveform is applied across the input leg of the closed loop resonant circuit with a second line polarity opposite to the first line polarity;
a second switcher circuit connected between the output leg of the closed loop resonant circuit and a load, the second switcher circuit comprising a plurality of switches controllable between:
a first configuration in which a chopped AC waveform presented across the output leg of the closed loop resonant circuit is applied across the load with a first chopped waveform polarity; and
a second configuration in which the chopped AC waveform is applied across the load with a second chopped waveform polarity opposite to the first chopped waveform polarity;
a controller connected to drive each of the first and second switcher circuits to alternate between their respective first and second configurations at a chopping frequency.

29. An AC/AC power converter according to claim 28 wherein the controller is connected to monitor a voltage of an output AC waveform across the load and to set the chopping frequency based on the monitored voltage.

30. An AC/AC power converter according to claim 29 wherein the controller comprises a data store containing data specifying a desired time-varying output waveform and the chopper is configured to set the chopping frequency based on deviations between the desired output waveform and the output AC waveform.
